(19) United States
(12) Patent Application Publication
(10) Pub. No.: US 2026/0281293 A1
(43) Pub. Date: Sep. 17, 2026

(54) AUTOSTEREOSCOPIC DISPLAY SYSTEMS AND METHODS FOR USING THE SAME

(71) Applicant: GOOGLE LLC, Mountain View, CA (US)

(72) Inventors: Xuejian Li, Fremont, CA (US); Haiwei Chen, San Jose, CA (US); Steven A. Cholewiak, Richmond, CA (US); John D. Perreault, Mountain View, CA (US); Bennett S. Wilburn, Saratoga, CA (US)

(21) Appl. No.: 19/561,018

(22) Filed: Mar. 9, 2026

Related U.S. Application Data
(60) Provisional application No. 63/771,435, filed on Mar. 13, 2025.

(51) Int. Cl. H04N 13/125; H04N 13/156; H04N 13/305; H04N 13/368; H04N 13/398

(52) U.S. Cl. CPC H04N 13/125; H04N 13/156; H04N 13/368; H04N 13/398; H04N 13/305

(57) ABSTRACT

An autostereoscopic display system may determine a stereoscopic pair of images, the stereoscopic pair of images including a left eye image and a right eye image. The autostereoscopic display system may determine first lighting parameters for a first subset of subpixels for forming the left eye image and second lighting parameters for a second subset of subpixels for forming the right eye image, wherein the first lighting parameters include a first intensity profile that includes a reduced intensity at a periphery of the first subset of subpixels to thereby reduce crosstalk.

### CROSS REFERENCE TO RELATED APPLICATION

This application claims the benefit of U.S. Provisional Application No. 63/771,435, filed Mar. 13, 2025, the disclosure of which is incorporated herein by reference in its entirety.

### BACKGROUND

Autostereoscopic displays provide a viewer with a perception of three-dimensional (3D) depth by displaying separate stereoscopic images for the viewer's left eye and right eye without requiring the use of separate headgear, such as glasses. Such systems are highly useful across a variety of consumer electronic devices, including televisions, laptop computers, tablet computers, computer monitors, and video gaming devices for perceiving images with 3D depth. One typical autostereoscopic configuration involves the use of a lenticular film overlying the display pixel array and the concurrent display of a stereoscopic pair of images that are interleaved, which results in the lenticular film directing the display light for the pixels of the left eye image and the display light for the pixels of the right eye image in slightly different directions.

### BRIEF DESCRIPTION OF THE DRAWINGS

FIG. 1 illustrates a top-down view of an autostereoscopic display system according to some implementations.

FIG. 2 illustrates an exploded cross sectional side view and functional block diagram of a display system according to some implementations.

FIG. 3 illustrates a cross-sectional view of a portion of a display panel according to some implementations.

FIG. 4 illustrates an example pixel intensity profile that is designed and configured to minimize crosstalk according to some implementations.

FIG. 5 illustrates an example pixel intensity profile that is designed and configured to minimize crosstalk according to some implementations.

FIG. 6 illustrates an example pixel intensity profile that is designed and configured to minimize crosstalk according to some implementations.

FIG. 7 illustrates an example pixel intensity profile that is designed and configured to minimize crosstalk according to some implementations.

FIG. 8 illustrates an example pixel intensity profile that is designed and configured to minimize crosstalk according to some implementations.

FIG. 9 illustrates an example pixel intensity profile that is designed and configured to minimize crosstalk according to some implementations.

FIG. 10 is a diagram illustrating parameters that may be used for correlating a phase of a subpixel to a direction in lab space relative to the display panel.

FIG. 11 is a flow diagram illustrating a method for providing 3D image display to multiple viewers using an autostereoscopic display system.

### DETAILED DESCRIPTION

Autostereoscopic display systems provide significant user benefits by allowing viewers to perceive three-dimensional (3D) depth without the burden of wearing specialized headgear, such as 3D glasses. A multi-viewer autostereoscopic display enhances this capability by employing a wide viewing cone and steerable backlights to direct separate, full-resolution 3D video streams to multiple individuals concurrently based on their physical locations. Such systems are highly useful across a variety of consumer electronic devices, including televisions, laptop computers, tablet computers, computer monitors, and video gaming devices for perceiving images with 3D depth. A multi-viewer autostereoscopic display is highly beneficial for video teleconferencing. For example, it can allow a family or group of colleagues to share a single display and each experience lifelike, natural 3D depth of a remote caller from their own unique viewing angle.

Autostereoscopic displays have a technical problem referred to as crosstalk in which light from one image of a pair of stereoscopic images reaches the wrong eye. Crosstalk can occur for a number of reasons, such as manufacturing or physics limitations, optical scattering in materials, and the like. In some examples light for one eye is scattered or deflected onto the wrong path and inadvertently reaches the other eye. Crosstalk can damage the quality of the perceived three-dimensional image. Implementations of the present disclosure include technical solutions that have the technical effect of removing or minimizing the perception of light in an unintended eye. In some implementations, the technical solutions include modifying one or more pixel assignments or pixel lighting parameters. In some examples, the pixels with modified lighting parameters are peripheral pixels that generate peripheral light that is closely adjacent to the light of the other eye's image. In some examples, the pixels with modified lighting parameters are interocular pixels that generate light that intersects an interocular region of a viewer.

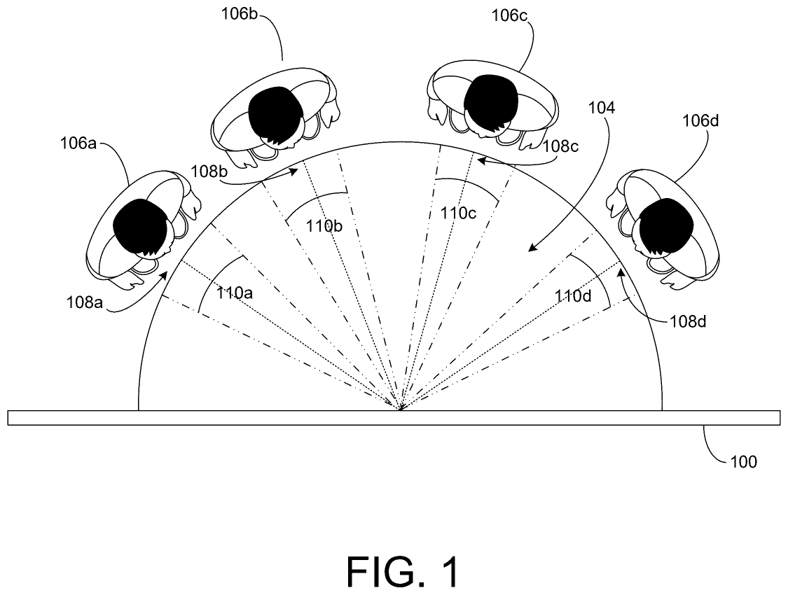

FIG. 1 is a top-down view of an autostereoscopic display system 100 made in accordance with the present disclosure that employs pixel lighting parameters that minimize crosstalk. In some examples, display system 100 is a multi-viewer autostereoscopic display that has a relatively wide viewing cone 104 that is designed and configured to support concurrent viewing by multiple viewers 106, e.g., viewers 106a, 106b, 106c, 106d. Display system 100 may be configured to provide time multiplexed stereoscopic images directed to viewpoints 108a, 108b, 108c, 108d associated with the location of the corresponding viewers 106a-106d, with each image displayed across a corresponding illumination cone 110a, 110b, 110c, 110d. In some examples, display systems of the present disclosure may be a single viewer display system rather than a multi-viewer system.

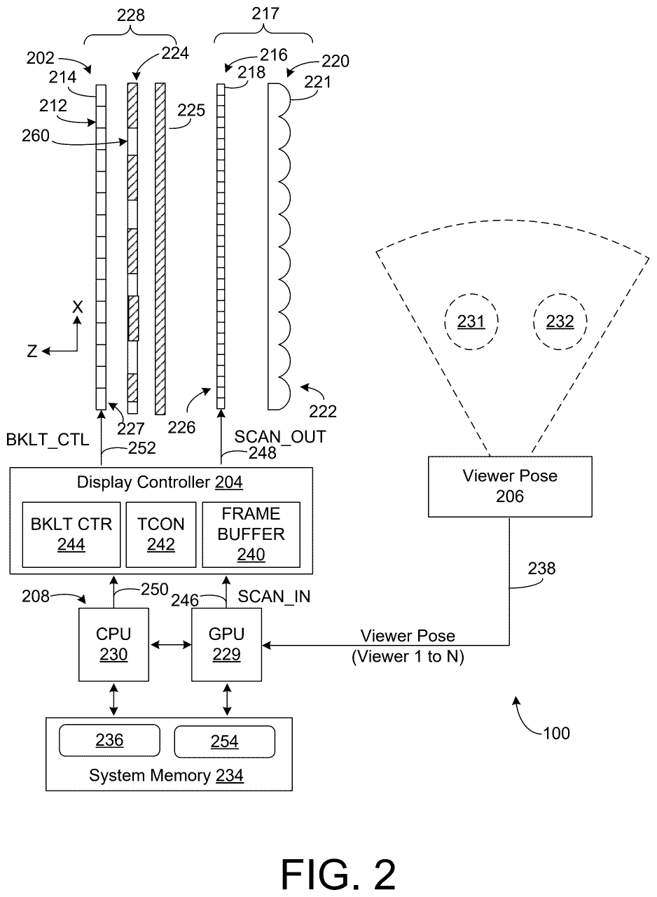

FIG. 2 is an exploded cross-sectional side view of a portion of display system 100 as well as a functional block diagram of portions of the display system. The display system 100 comprises any of a variety of electronic systems utilized to display video or other imagery, including computer monitors, video gaming devices, televisions, tablet computers, laptop computers, and other panel displays. The display system 100 includes a display panel 202, a display controller 204, a viewer pose subsystem 206, and a video subsystem 208. Although illustrated as separate from the display panel 202 for ease of reference, in some examples one or more of the display controller 204, viewer pose subsystem 206, and video subsystem 208 may be integrated as part of the display panel 202. The cross-sectional view of the display panel 202 is a top view, the section view taken along a horizontal section line (a section line parallel to a ground surface when the display is in an orientation for normal use) through the display panel.

In the illustrated example, display panel 202 is a transmissive-type display panel that includes a backlight 212 composed of a matrix or other two-dimensional array of backlight pixels 214, e.g., white-light LEDs, and a selectively-transmissive display pixel matrix 216 similarly composed of a matrix or other two-dimensional array of transmissive display pixels 218, e.g., composed of red, green, and blue (RGB) sub pixel LEDs. The selectively-transmissive display pixel matrix 216 and a lenticular array 220 form a 3D image modulation unit 217 that modulates stereoscopic image information to generate a 3D image. The transmissive display pixels 218 can include any of a variety of display pixels configured to selectively filter or block incident backlight from the backlight 212 based on a corresponding pixel value in order to configure the resulting transmitted light to affect a particular color and intensity. Examples of such transmissive display pixels include active-matrix or passive-matrix liquid crystals (LCs), such as thin-film-transistor (TFT) LCs. In some examples, the display pixel matrix 216 has a higher resolution, for example, a greater number of pixels, than the backlight 212. In other examples, the resolution of the backlight 212 may meet or exceed the resolution of the display pixel matrix 216. The lenticular array 220 is overlying or otherwise disposed adjacent to a viewer facing side 222 of the display pixel matrix 216. The lenticular array 220, in one example, is composed of an array or other matrix of lenses 221, sometimes referred to as lenticules, that refract light transmitted by the selectively-transmissive display pixel matrix 216 to direct the light to a viewer's left or right eye. The overlay of the lenticular array 220 and the display pixel matrix 216, when used in conjunction with display of a composite 3D frame composed of an interleaved, e.g., by column, stereoscopic pair of images, presents three-dimensional stereoscopic display content to a viewer.

In the illustrated example, the backlight 212 is part of a steerable backlight unit 228, which also includes a parallax barrier 224, and a diffuser 225. The parallax barrier 224 and diffuser 225 are disposed between, and substantially parallel to, a back-facing side 226 of the display pixel matrix 216 and a front-facing side 227 of the backlight 212. In an example, the parallax barrier 224 includes an opaque layer in which transparent apertures 260 are formed. The apertures 260 are parallel and evenly spaced and, in some examples, extend vertically with respect to an intended orientation of the display. In some examples any of a variety of other parallax barrier designs may be used, including dynamic or moving parallax barriers, such as an electrically controlled parallax barrier. In some examples, the steerable backlight unit 228 may include one or more components instead of or in addition to parallax barrier 224 and/or diffuser 225. For example, steerable backlight unit 228 may include a second lenticular array (not illustrated) in the place of parallax barrier 224 for steering light emitted by backlight 212 in a desired direction. In some examples, a display system of the present disclosure may not include a steerable backlight unit, for example, parallax barrier 224 and/or diffuser 225 may be omitted.

The physical arrangement of the backlight 212, parallax barrier 224, diffuser 225, selectively-transmissive display pixel matrix 216, and lenticular array 220 has the effect that backlight emitted by a particular backlight pixel 214 is directed by the parallax barrier 224 and diffuser 225 through the selectively-transmissive display pixel matrix 216 and then through the lenticular array 220 in a particular direction. As such, display light resulting from the modification of emitted backlight as it traverses the selectively-transmissive display pixel matrix 216 is emitted by the display panel 202 in a particular direction (relative to the display surface of the display panel 202) that is based on the particular location of the backlight pixel 214 that emitted the backlight. Accordingly, the backlight 212 is configured to permit different subsets of backlight pixels 214 to be activated separately, and through the activation of a particular subset of backlight pixels 214, the resulting display light emitted by the display panel 202 can be controlled to be emitted in a corresponding direction. In this manner, the backlight 212, parallax barrier 224 and diffuser 225 collectively operate as the steerable backlight unit 228 that is operable to steer display light representative of the visual content of a frame being displayed in a particular direction. As such, the display panel 202 can be controlled to steer different successive displayed images to different viewer locations, and thus allow 3D content to be viewed by multiple viewers concurrently without requiring the viewers to wear special headgear.

The display system 100 may include a viewer pose subsystem 206 to determine the pose of each of one or more viewers, such as the two viewers 231, 232 illustrated in FIG. 2. The viewer pose subsystem 206 includes any of a variety of systems employed for determining head and/or eye pose known in the art. For example, the viewer pose subsystem 206 can include a stereoscopic camera subsystem that utilizes reflected infrared (IR) light or other structured light to detect the presence of a viewer's face and further to detect the position and orientation, also referred to as the pose, of a viewer's eyes relative to the display panel 202. For ease of reference, the systems and techniques of the present disclosure generally are described in the context of eye pose, but these descriptions apply equally to determining head pose more generally, and thus reference to a viewer's pose refers to any of a relative position of one or both eyes of a viewer, an orientation of one or both eyes of a viewer, a relative position of a head of a viewer, an orientation of the head of a viewer, or combinations thereof, unless otherwise noted. Further, for purposes of the following, the viewer's pose is described herein with reference to the display surface of the display panel 202, for example, an X-Y plane defined by the display panel 202, at a point at, for example, the center of the display panel 202. In some examples, the pose may be defined relative to a different fixed reference, such as a midpoint between two cameras of the pose subsystem 206, a specified corner of the display panel 202, and the like.

The video subsystem 208, in one example, includes one or more processors, such as at least one central processing unit (CPU) 230 and at least one graphics processing unit (GPU) 229, at least one system memory 234, and various input/output (I/O) devices, mass storage devices, and the like (not illustrated). The system memory 234 stores one or more software programs executed by one or both of the CPU 230 and GPU 229, such as a video generation software application 236 that includes executable instructions that manipulate the CPU 230 and GPU 229 to generate sequences of image frames also referred to herein as frames, for one or more viewers. The video generation software application 236 can include, for example, a rendering-based application that renders frames composed primarily of computer graphics, such as a video game application, a decoding-based application that generates frames by decoding previously-encoded frames (such as a television streaming application), or a combination thereof (such as an augmented reality application that renders an AR overlay for a decoded real-world video stream).

In an example, the generated frames are 3D composite frames that include a left eye image interlaced with a right eye image, the left eye image and right eye image together forming a stereoscopic image pair that when viewed by the respective left eye and right eye of a viewer provides the viewer with stereoscopic perception of depth such that images have the appearance of solidity and relief as though seen in three dimensions, also referred to herein as a 3D image. In some examples, the 3D composite frames may also include at least one additional image interlaced with the left eye image and the right eye image which is designed and configured to minimize the perception of crosstalk between the left eye image and the right eye image. In some examples, a pixel assignment or a pixel lighting parameter for one or more pixels is modified or configured to minimize crosstalk.

In some examples, the video subsystem 208 generates separate streams for a pose of each viewer, e.g., viewer 231 and viewer 232, by the viewer pose subsystem 206. For example, the video subsystem 208 may generate one stream of composite frames for viewer 231 and another stream of composite frames for viewer 232. The GPU 229 may utilize viewer pose information 238 for a given viewer as determined and provided by the viewer pose subsystem 206 to generate the corresponding video stream to reflect that viewer's current pose in the visual content represented in the frames of the video stream. For example, the visual content represented in the frames can be rendered so as to correspond to the perspective of the viewer relative to the display panel 202 as based on the viewer's current pose.

In the illustrated example, the display controller 204 includes a frame buffer 240, a timing controller (TCON) 242, and a backlight controller 244. The display controller 204 may be implemented as, for example, a display driver integrated circuit (DDIC) that can be part of the display panel 202 itself, as part of the video subsystem 208, or a component disposed between the two. The frame buffer 240 may be implemented as, for example, graphics random access memory (GRAM) or, in some examples, part of the system memory 234, and operates to temporarily buffer the pixel data of frames generated by the video subsystem 208 and transferred from the GPU 229 via a SCAN_IN signal 246. The timing controller 242 is coupled to the frame buffer 240 and may include clock sources and programmable or fixed logic operable to transfer the pixel data stored for a frame in the frame buffer 240 to the display pixel matrix 216, for example, on a line-by-line basis using a SCAN_OUT signal 248 as well as various other timing and control signals using any of a variety of techniques or protocols known in the art.

The backlight controller 244 (denoted BLK_CTR in FIG. 2) is coupled to the timing controller 242 and has an input to receive backlight configuration information 250 from the CPU 230 or other component of the video subsystem 208, and based on the backlight configuration information 250 generate a backlight control (BKLT_CTL) signal 252 that selectively activates a corresponding subset of backlight pixels 214 of the backlight 212 to steer or direct resulting display light emitted by the display panel 202 in a corresponding direction. In an example, the system memory 234 includes a viewer steering application 254 that includes executable code that manipulates the CPU 230 to identify, for a selected viewer, the viewer's current pose from the viewer pose information 238 provided by the viewer pose subsystem 206, determine a direction of that viewer relative to the display panel 202 based on the viewer's current pose, and then provide a representation of the determined direction to the backlight controller 244 as the backlight configuration information 250. Then, as noted above, the backlight controller 244 activates a corresponding subset of backlight pixels 214 so that the emitted backlight is steered through the selectively-transmissive display pixel matrix 216 by the parallax barrier 224 and diffuser 225 in a direction that intercepts the viewer's current position, and thus presenting the visual content of the frame currently displayed at the selectively-transmissive display pixel matrix 216 in the emitted display light.

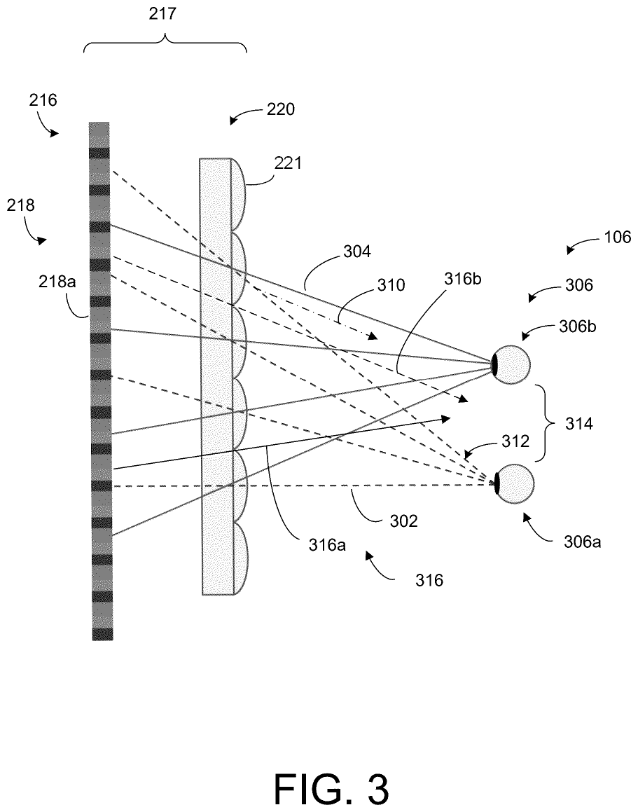

FIG. 3 conceptually illustrates a top cross-sectional view of a portion of display panel 202 in use. FIG. 3 shows a portion of selectively-transmissive display pixel matrix 216 including several display pixels 218 which consist of corresponding subpixels 218a. FIG. 3 shows a subset of the subpixels 218a emitting left eye image light 302, which may also be referred to as a left-eye-image subset of the subpixels 218a. FIG. 3 also shows a subset of the subpixels 218a emitting right eye image light 304, which may also be referred to as a right-eye-image subset of the subpixels 218a. The left eye image light 302 is transmitted and refracted through lenticular array 220 and corresponding lenses 221 to intersect the left eye 306a of a viewer and the right eye image light 304 is similarly transmitted through lenticular array 220 to intersect the right eye 306b. (Note the illustrated light ray traces in FIG. 3 for the left eye image light 302 and right eye image light 304 are shown as straight lines for ease of illustration, however, the actual paths of light through the lenticular array 220 would include one or more bends.) FIG. 3 conceptually illustrates how light from various display pixels 218 may reach one of the eyes 306 of the viewer 106 depending on the location of the viewer 106, the location of a pixel 218 relative to a lens 221. FIG. 3 also illustrates an interleaving of the left eye image light 302 and right eye image light 304 from alternating columns of the transmissive display pixels 218.

FIG. 3 conceptually illustrates an example of a scattered portion 310 of the left eye image light 302 that has diverged from an intended path towards the left eye 306a and is instead directed towards the right eye 306b, which may cause a deterioration of the composite 3D image frame, such as crosstalk. In the illustrated example, the scattered portion 310, or divergent portion or diffused portion, of the left eye image light 302 is located along an inner periphery 312 of the left eye image light 302, for example, a side of the left eye image light 302 that is closer to the right eye 306b or adjacent or directly adjacent the right eye 306b or adjacent or directly adjacent or intersecting an interocular region 314.

FIG. 3 also shows interocular light 316a, 316b, which is directed to the interocular region 314 of the viewer 106. In an example, light emitted from some number or some subset of the subpixels 218a may intersect the interocular region 314 of the viewer 106 and not reach the pupils of the viewer's eyes 306. The subset of subpixels 218a that emit light to the interocular region 314 for a given viewer pose may be referred to as an interocular subset of subpixels. The proximity of the interocular light 316 to both eyes 306 increases the probability of the interocular light reaching an unintended eye, for example, interocular light 316 with right eye image content inadvertently reaching the left eye 306a.

Aspects of the present disclosure include pixel assignments and pixel light parameter profiles that are designed and configured to minimize the negative influence of scattered light such as scattered portion 310 on the 3D composite image, for example, minimize or eliminate crosstalk caused by such scattered light. Pixel assignments and pixel light parameter profiles of the present disclosure may also be designed and configured to define different light parameters for the interocular subset of subpixels than the right-eye-image or left-eye image subsets of the subpixels 218a to minimize crosstalk caused by the interocular light 316.

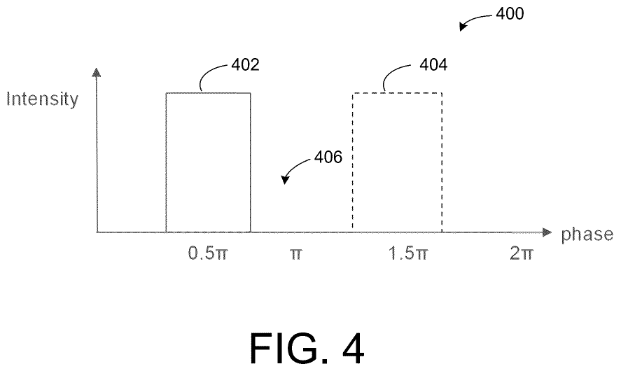

FIG. 4 is an example of a pixel intensity profile 400 of the present disclosure that is designed and configured to minimize crosstalk. In FIG. 4, the vertical axis is light intensity and the horizontal axis is phase. In an example, phase is a parameter for correlating a given subpixel, such as one of subpixels 218a, to a given angle in a lab space frame of reference. In an example, a phase of π is defined as a midpoint between a viewer's eyes, for example, an interpupillary midpoint or an interocular midpoint. A viewer pose system, such as the viewer pose subsystem 206, may be used to determine a location or pose of a viewer with respect to the display, which can be used to determine an angle between the viewer and the front surface of the display. Subpixels 218a whose emitted light would fall to a first side, such as the left side of the midpoint between the viewer's eyes are assigned a phase value between 0 and π and the remaining subpixels whose emitted light would fall to a second side, for example the right side of the midpoint between the viewer's eyes are assigned a phase value between π and 2π.

The example pixel intensity profile 400 includes a left eye image pixel intensity profile 402 and a right eye image pixel intensity profile 404. In the illustrated example, both the left eye image pixel intensity profile 402 and right eye image pixel intensity profile 404 are square waves centered at 0.5π, and 1.5π, respectively. The example square waves collectively have a width that corresponds to approximately 50% of the subpixels 218a of the selectively-transmissive display pixel matrix 216 emitting light and approximately 50% of the subpixels 218a being dark, or not emitting light.

The pixel intensity profile 400 also includes an interocular image pixel intensity profile 406 having a width and centered at π radians, or the interpupillary midpoint. In the illustrated example subpixels 218a assigned to the interocular image pixel intensity profile 406, for example, some portion of the interocular subset of subpixels, are controlled to not emit light.

The width of the square waves of the left eye image pixel intensity profile 402 and the right eye image pixel intensity profile 404 may be adjusted or tuned to optimize image quality. In an example, decreasing the width of the square waves, resulting in a greater proportion of the subpixels 218a being off and not emitting light, may have a positive effect of reducing a level of crosstalk, but may also have negative effects, such as image nonuniformity or an increase in view jumpiness.

The left eye image pixel intensity profile 402 may be part of a first set of lighting parameters for causing a first subset of subpixels to form a left eye image of a stereoscopic pair of images. The right eye image pixel intensity profile 404 may be part of a second set of lighting parameters for causing a second subset of subpixels to form a right eye image of the stereoscopic pair of images. The first lighting parameters may include a first intensity profile, e.g., left eye image pixel intensity profile 402, that includes a reduced intensity. For example, a portion of the interocular image pixel intensity profile 406, which may be at a periphery of the first subset of subpixels, or a periphery of the first image, to thereby reduce crosstalk.

The interocular image pixel intensity profile 406 may be an example of a third intensity profile that includes an intensity value of zero. In the illustrated example, a third intensity profile, e.g. interocular image pixel intensity profile 406, includes a maximum intensity value, here zero, that is less than a maximum intensity value of a first intensity profile, e.g., a maximum value of the left eye image pixel intensity profile 402.

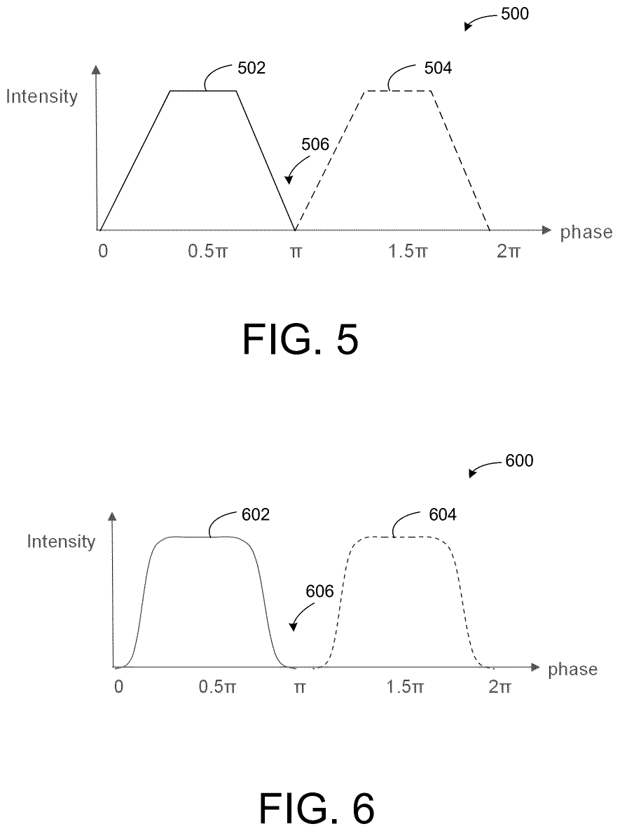

FIG. 5 illustrates another example of a pixel intensity profile 500 including a left eye image pixel intensity profile 502 and a right eye image pixel intensity profile 504. The pixel intensity profile 500 includes a linear reduction in light intensity over an interocular portion 506 of the pixel intensity profile 500. Substantially all of the subpixels 218a located to the left of the interocular midpoint, e.g., having a phase between 0 and π, emit left eye image light and the remaining subpixels between π and 2π emit right eye image light. The relative intensity of the light emitted by the subpixels 218a decreases with proximity to the interocular midpoint. By reducing the intensity of light emitted by the interocular subset of subpixels, and in some examples, light emitted by some of the left eye-image subset and/or right eye-image subset of subpixels, the crosstalk caused by the light emitted by those subpixels is reduced.

FIG. 6 illustrates another example of a pixel intensity profile 600 including a left eye image pixel intensity profile 602 and a right eye image pixel intensity profile 604. The pixel intensity profile 600 includes a non-linear reduction in light intensity over an interocular portion 606 of the pixel intensity profile 600. Substantially all of the subpixels 218a located to the left of the interocular midpoint, e.g., having a phase between 0 and π, emit left eye image light and the remaining subpixels between π and 2π emit right eye image light. The relative intensity of the light emitted by the subpixels 218a decreases with proximity to the interocular midpoint. By reducing the intensity of light emitted by the interocular subset of subpixels, and in some examples, light emitted by some of the left eye-image subset and/or right eye-image subset of subpixels, the crosstalk caused by the light emitted by those subpixels is reduced.

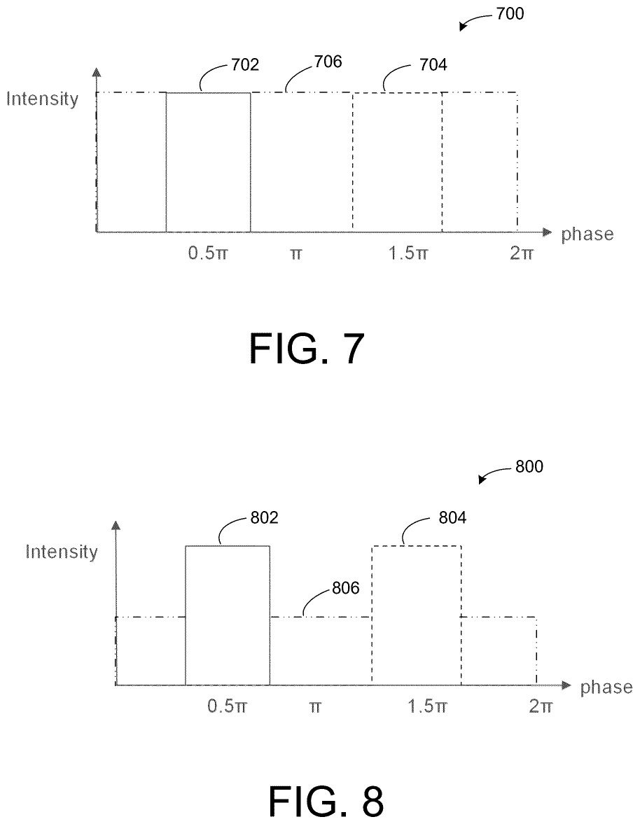

FIG. 7 illustrates another example of a pixel intensity profile 700 that is similar to pixel intensity profile 400 and includes a left eye image pixel intensity profile 702 and a right eye image pixel intensity profile 704. Unlike pixel intensity profile 400, the example pixel intensity profile 700 also includes a third image pixel intensity profile 706 for emitting light content that is different than the light content of a left eye image or right eye image for forming a third image that is different than the left or right eye image. In an example, at least a portion of an interocular subset of subpixels emit light according to the third image pixel intensity profile 706. In the illustrated example, a relative intensity of light emitted according to the third image pixel intensity profile 706 is substantially the same as the intensity of the left eye image pixel intensity profile 702 and the right eye image pixel intensity profile 704.

The third image formed by the third image pixel intensity profile 706 may be any of a variety of images. For example, the third image may be an image from an interocular midpoint perspective, for example, a perspective between the left eye image perspective and the right eye image perspective. In an example, the third image may be an average or blend of the left eye image and the right eye image. In an example, the third image may be one or more colors or form one or more patterns or may be unrelated to the left or right eye image. In an example, a left eye image is a first image of a scene from a first perspective, a right eye image is a second image of the scene from a second perspective, and a third image formed by, for example, the third image pixel intensity profile 706, is a third image of the scene from a third perspective that is different than the first perspective or the second perspective.

FIG. 8 illustrates another example of a pixel intensity profile 800 that is similar to pixel intensity profile 700 and includes a left eye image pixel intensity profile 802, a right eye image pixel intensity profile 804 and a third image pixel intensity profile 806 for emitting light content that is different than the light content of a left eye image or right eye image for forming a third image that is different than the left or right eye image. In an example, at least a portion of an interocular subset of subpixels emit light according to the third image pixel intensity profile 806. In the illustrated example, a relative intensity of light emitted according to the third image pixel intensity profile 806 is lower or less than the intensity of the left eye image pixel intensity profile 802 or the right eye image pixel intensity profile 804.

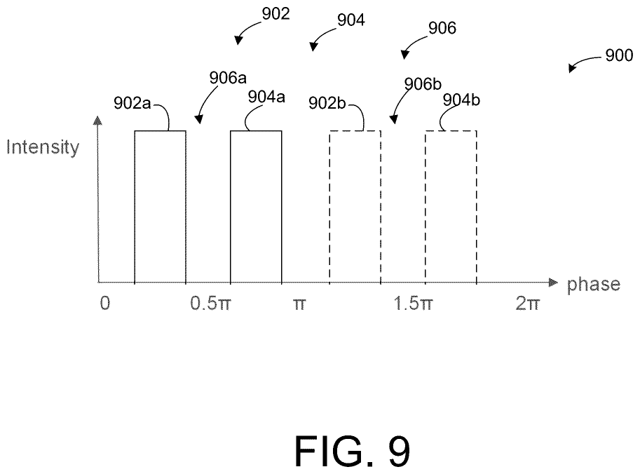

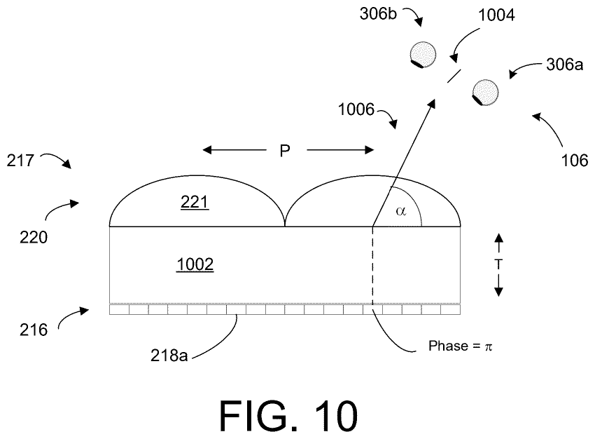

FIG. 9 is an example of a multi-viewer pixel intensity profile 900 of the present disclosure that is designed and configured to minimize crosstalk. The multi-viewer pixel intensity profile 900 is similar to the pixel intensity profile 400 but applied to two concurrent viewers. In the illustrated example a phase of 0.5π is defined as an interocular midpoint between a first viewer's eyes and a phase of 1.5π is defined as an interocular midpoint between a second viewer's eyes. Subpixels 218a whose emitted light would fall to a first side, such as the left side of the interocular midpoint of the first viewer are assigned a phase value between 0 and 0.5π, subpixels whose emitted light would fall to a right side of the interocular midpoint of the first viewer are assigned a phase value between 0.5π and π. Subpixels 218a whose emitted light would fall to a left side of the interocular midpoint of the second viewer are assigned a phase value between π and 1.5π, and subpixels whose emitted light would fall to a right side of the interocular midpoint of the second viewer are assigned a phase value between 1.5π and 2π. In other examples including more than two viewers the angle space of the view cone of the system can be further divided between the three or more viewers.

The example pixel intensity profile 900 includes a left eye image pixel intensity profile 902a and a right eye image pixel intensity profile 904a for a first viewer and a left eye image pixel intensity profile 902b and a right eye image pixel intensity profile 904b for a second viewer. In the illustrated example, both the left eye image pixel intensity profiles 902 and right eye image pixel intensity profiles 904 are square waves. In other examples, the pixel intensity profiles can have any shape including any of the shapes disclosed herein such as a linear or non-linear reduction in intensity as a distance to the interocular midpoint of a viewer decreases. The example square waves of multi-viewer pixel intensity profile 900 have a width that corresponds to approximately 50% of the subpixels 218a of the selectively-transmissive display pixel matrix 216 emitting light and approximately 50% of the subpixels 218a being dark, or not emitting light. The pixel intensity profile 900 also includes an interocular image pixel intensity profile 906a aligned with the interocular midpoint of the first viewer and an interocular image pixel intensity profile 906b aligned with the interocular midpoint of the second viewer. In the illustrated example, subpixels 218a assigned to the interocular image pixel intensity profiles 906, for example, some portion of an interocular subset of subpixels, are controlled to not emit light. In other examples the interocular subset of subpixels may emit light, for example, to form a third image. The width of the square waves of the left eye image pixel intensity profiles 902 and the right eye image pixel intensity profiles 904 may be adjusted or tuned to optimize image quality.

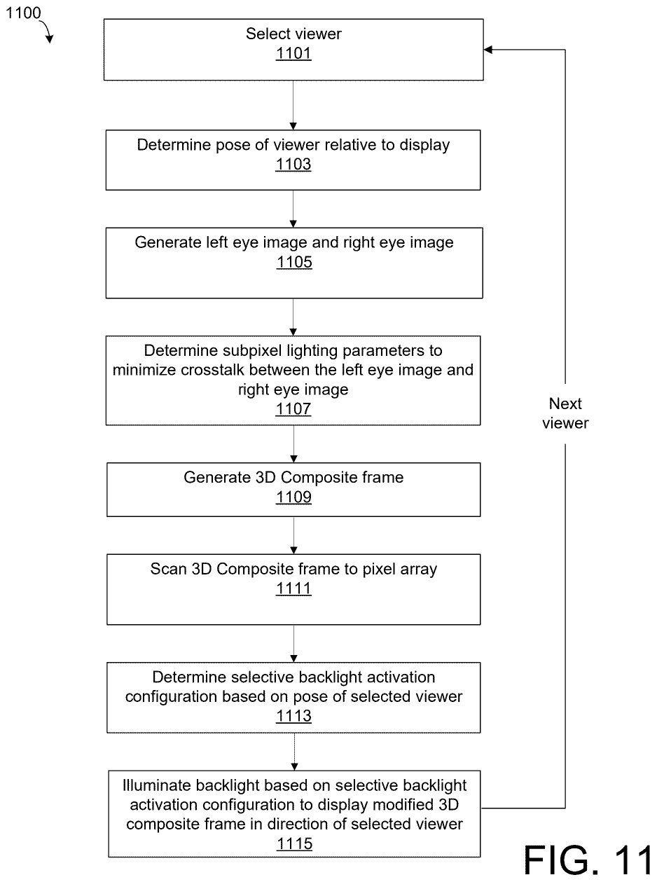

FIG. 10 is a diagram illustrating parameters that may be used for correlating a phase of a subpixel 218a to pose of a viewer 106. FIG. 10 is a detail top down cross-sectional view of a portion of the image modulation unit 217 which includes the selectively-transmissive display pixel matrix 216 and the lenticular array 220. FIG. 10 shows two lenses 221 of the lenticular array 220, a portion of the subpixels 218a aligned with the lenses 221 and a spacer 1002 located therebetween. FIG. 10 conceptually illustrates a pose of a viewer 106 and an interocular midpoint 1004 located at a midpoint between the left eye 306a and the right eye 306b of the viewer 106. At the current pose of the viewer 106, there is a corresponding angle, «, between the interocular midpoint 1004 and the display surface of the display, which can be determined from viewer pose information 238 generated by viewer pose subsystem 206 (see FIG. 2). A ray 1006 indicates an expected path of light emitted by a subpixel 218a that will intersect the interocular midpoint 1004. In the case of a single viewer, the subpixel 218a emitting light ray 1006 that is aligned with the interocular midpoint 1004 may be assigned a phase position of π. The subpixels 218a may be controlled to emit light according to lighting parameters that includes a pixel intensity profile such as one of pixel intensity profiles 400, 500, 600, 700, or 800.

In an example, a relationship between the angle, «, and the phase position of a subpixel 218a may be defined by the following Equation 1.

$$α = \frac{P}{T} \times \frac{phase}{2 π} \qquad Equation 1$$

Wherein:
α is an angle with respect to a display surface of the display in lab space;
P is a pitch of the lenses 221 of the lenticular array 220;
T is a thickness of the spacer 1002 between the lenses 221 and a light emitting surface of the subpixels 218a; and
Phase is a fraction of the full repeat cone of the optical system extending between 0 and 2π.

FIG. 11 is a flowchart illustrating an example method 1100 of a multi-viewer operation of the display system 100 of FIGS. 1 and 2.

As illustrated, the method 1100 includes, at block 1101, selecting a viewer and at block 1103, determining a pose of the selected viewer relative to the display utilizing, for example, the viewer pose subsystem 206. The viewer pose subsystem 206 may use any of a variety of techniques to identify the presence of each viewer present within a certain range of the display surface of the display panel 202, and for each identified viewer, monitor a current viewer pose for that viewer. For example, the viewer pose subsystem 206 can use any of a variety of face detection algorithms to detect the presence of a viewer's face and then utilize any of a variety of pose detection algorithms to detect the location and orientation of the detected face, or in some instances, the eyes of the detected face, and repeatedly update this information. Such techniques can utilize stereoscopic image capture and analysis, and in some examples, depth sensing using IR light or structured light projection, and the like. The current viewer pose for each detected viewer, such as viewers 231 and 232 of FIG. 2, may then be periodically transmitted to the video subsystem 208 as viewer pose information 238, as described above. A similar process may be implemented for determining a pose of a single viewer.

After determining the pose of the selected viewer, a composite frame may be displayed to the selected viewer by steering display light generated by the display panel 202 via the steerable backlight unit 228 such that the display light is projected from the display panel 202 in a direction that intercepts the current pose of the corresponding viewer. For example, at block 1105, execution of the video generation software application 236 at the video subsystem 208 may cause the GPU 229 to generate a left eye image and a right eye image for a given image frame. At block 1107, the video generation software application 236 may also include instructions for causing the video subsystem 208 to determine one or more subpixel lighting parameters to minimize crosstalk between the left eye image and the right eye image. Any combination of the methods disclosed herein may be applied to minimize crosstalk, including applying one or more of the pixel intensity profiles disclosed herein.

At block 1109, the video generation software application 236 may also include instructions for causing the GPU 229 to generate a 3D composite frame of the left eye image and right eye image along with the subpixel lighting parameters generated at block 1107 and buffer the composite frame in the frame buffer 240. In some examples the combination of the left and right eye images is implemented in an alternating column or interleaved approach, such that, for example, the even columns of the composite frame contain the columns of the left eye image while the odd columns of the composite frame contain the columns of the right eye image. As is known in the art, when such a composite frame is viewed through a lenticular array, such as the lenticular array 220, the particular view angles presented by the lenticules result in separation of the display light emitted from the even columns into display light transmitted to one exit pupil (e.g., the left eye exit pupil) and display light emitted from the odd columns into display light transmitted to another exit pupil (e.g., the right eye exit pupil). In at least one example, the CPU 230 receives the current viewer pose information 238 for the selected viewer and directs the GPU 229 to render the composite frame so as to reflect the current viewer pose using any of a variety of well-known or proprietary 3D rendering techniques, such as those frequently employed to provide a sense of depth for virtual reality (VR) headsets or augmented reality (AR) headsets based on a pose of the viewer relative to a reference coordinate system for a virtual world or the real world. At block 1111 the method may include scanning the composite frame to the pixel array.

At block 1113, execution of the viewer steering application 254 manipulates the CPU 230 to identify a selective backlight activation configuration that, in conjunction with the parallax barrier 224 and diffuser 225, cause emitted backlight to be steered through the display pixel matrix 216 in a direction that will intercept the viewer at the current viewer pose detected for that viewer. The viewer steering application 254 then provides a representation of the identified selective backlight activation configuration as backlight configuration information 250 for the upcoming frame period. This selective backlight activation configuration represents a corresponding subset of backlight pixels 214 that, when activated at block 1115, emit backlight that is then collimated by parallax barrier 224 and transmitted at a corresponding angle relative to the plane of the selectively-transmissive display pixel matrix 216, and thus result in transmission of the resulting display light in the intended direction to intercept the viewer.

The method 1100 may then return to block 1101 for selection of the next viewer and, in a subsequent image frame, display of a 3D composite image to the selected viewer. Thus, in one iteration of method 1100 for a corresponding frame period, a 3D image is generated and displayed in the expected direction of a selected viewer. For the next frame period, a next iteration of the method is performed for the next selected viewer, resulting in generation of a 3D image and display of that 3D image in the direction of the next selected viewer, and so forth. In this manner, 3D images can be generated and steered to different viewers in an interleaved pattern, resulting in multiple interleaved video streams being presented to multiple viewers concurrently. For example, if the display system 100 has a refresh rate of 120 frames per second (fps) and there are two viewers, then each viewer can be presented a separate video stream at an effective rate of 60 fps. Similarly, if there are three viewers, then a separate 3D video stream can be displayed to each viewer at an effective rate of 40 frames per second. Thus, through the use of a parallax barrier-steerable backlight as described herein, multiple viewers each can be presented with a separate 3D video stream at the full resolution of the display panel 202, and with only the frame rate being primarily affected based on the number of viewers being concurrently supported.

Example implementations can include a non-transitory computer-readable storage medium comprising instructions stored thereon that, when executed by at least one processor, are configured to cause a computing system to perform any of the methods described above. Example implementations can include an apparatus including means for performing any of the methods described above. Example implementations can include an apparatus including at least one processor and at least one memory including computer program code, the at least one memory and the computer program code configured to, with the at least one processor, cause the apparatus at least to perform any of the methods described above.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (a LED (light-emitting diode), or OLED (organic LED), or LCD (liquid crystal display) monitor/screen) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of examples have been described. Nevertheless, it will be understood that various modifications may be made without departing from the spirit and scope of the specification.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other examples are within the scope of the following claims.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

While example embodiments may include various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the claims. Like numbers refer to like elements throughout the description of the figures.

Some of the above example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed above, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for purposes of describing example embodiments. Example embodiments, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term and/or includes any and all combinations of one or more of the associated listed items.

It will be understood that when an element is referred to as being connected or coupled to another element, it can be directly connected or coupled to the other element or intervening elements may be present. In contrast, when an element is referred to as being directly connected or directly coupled to another element, there are no intervening elements present. Other words used to describe the relationship between elements should be interpreted in a like fashion (e.g., between versus directly between, adjacent versus directly adjacent, etc.).

The terminology used herein is for the purpose of describing particular embodiments only and is not intended to be limiting of example embodiments. As used herein, the singular forms a, an and the are intended to include the plural forms as well, unless the context clearly indicates otherwise. It will be further understood that the terms comprises, comprising, includes and/or including, when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the above example embodiments and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative embodiments, reference to acts and symbolic representations of operations (e.g., in the form of flowcharts) that may be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as processing or computing or calculating or determining of displaying or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example embodiments are typically encoded on some form of non-transitory program storage medium or implemented over some type of transmission medium. The program storage medium may be magnetic (e.g., a floppy disk or a hard drive) or optical (e.g., a compact disk read only memory, or CD ROM), and may be read only or random access. Similarly, the transmission medium may be twisted wire pairs, coaxial cable, optical fiber, or some other suitable transmission medium known to the art. The example embodiments not limited by these aspects of any given implementation.

Lastly, it should also be noted that whilst the accompanying claims set out particular combinations of features described herein, the scope of the present disclosure is not limited to the particular combinations hereafter claimed, but instead extends to encompass any combination of features or embodiments herein disclosed irrespective of whether or not that particular combination has been specifically enumerated in the accompanying claims at this time.

What is claimed is:

1. A method of operating an autostereoscopic display, the method comprising:
determining a stereoscopic image pair, the stereoscopic image pair including a left eye image and a right eye image;
identifying a first subset of a plurality of subpixels for forming the left eye image; and
applying a first intensity profile to the first subset that includes a reduced intensity at a periphery of the left eye image to thereby reduce crosstalk.

2. The method of claim 1, further comprising:
identifying a second subset of the plurality of subpixels for forming the right eye image; and
identifying a third subset of the plurality of subpixels located between the first subset and the second subset;
wherein an intensity of light emitted by the third subset is lower than an intensity of light emitted by the first subset.

3. The method of claim 2, further comprising:
determining a third image; and
forming the third image with the third subset.

4. The method of claim 3, wherein the left eye image is a first image of a scene from a first perspective, the right eye image is a second image of the scene from a second perspective, and the third image is a third image of the scene from a third perspective, the third perspective different than the first perspective or the second perspective.

5. The method of claim 3, wherein the third image is a combination of the left eye image and the right eye image.

6. The method of claim 2, wherein the third subset are an interocular subset of the plurality of subpixels that emit light that intersects an interocular region of a viewer.

7. The method of claim 1, further comprising, determining a pose of a first viewer, wherein the identifying a first subset of a plurality of subpixels includes identifying the first subset according to the determined pose of the first viewer.

8. The method of claim 1, further comprising:
displaying the stereoscopic image pair to a first viewer; and
displaying a second stereoscopic image pair to a second viewer, the second stereoscopic image pair including a second left eye image and a second right eye image;
wherein the first intensity profile includes a second reduced intensity at a periphery of the second left eye image.

9. A computer-readable storage medium having stored thereon computer-executable instructions that when executed by a processor perform a method comprising:
determining a stereoscopic image pair, the stereoscopic image pair including a left eye image and a right eye image;
identifying a first subset of a plurality of subpixels for forming the left eye image; and
applying a first intensity profile to the first subset that includes a reduced intensity at a periphery of the left eye image to thereby reduce crosstalk.

10. The computer-readable storage medium of claim 9, further comprising:
identifying a second subset of the plurality of subpixels for forming the right eye image; and
identifying a third subset of the plurality of subpixels located between the first subset and the second subset;
wherein an intensity of light emitted by the third subset is lower than an intensity of light emitted by the first subset.

11. The computer-readable storage medium of claim 10, further comprising:
determining a third image; and
forming the third image with the third subset.

12. The computer-readable storage medium of claim 11, wherein the left eye image is a first image of a scene from a first perspective, the right eye image is a second image of the scene from a second perspective, and the third image is a third image of the scene from a third perspective, the third perspective different than the first perspective or the second perspective.

13. The computer-readable storage medium of claim 11, wherein the third image is a combination of the left eye image and the right eye image.

14. The computer-readable storage medium of claim 10, wherein the third subset of subpixels are an interocular subset of the subpixels that emit light that intersects an interocular region of a viewer.

15. A system, comprising:
a processor; and
a memory comprising instructions that when executed by the processor, cause the processor to perform a method comprising:
determining a stereoscopic image pair, the stereoscopic image pair including a left eye image and a right eye image;
identifying a first subset of a plurality of subpixels for forming the left eye image; and
applying a first intensity profile to the first subset that includes a reduced intensity at a periphery of the left eye image to thereby reduce crosstalk.

16. The system of claim 15, further comprising:
identifying a second subset of the plurality of subpixels for forming the right eye image; and
identifying a third subset of the plurality of subpixels located between the first subset and the second subset;
wherein an intensity of light emitted by the third subset is lower than an intensity of light emitted by the first subset.

17. The system of claim 16, further comprising:
determining a third image; and
forming the third image with the third subset.

18. The system of claim 17, wherein the left eye image is a first image of a scene from a first perspective, the right eye image is a second image of the scene from a second perspective, and the third image is a third image of the scene from a third perspective, the third perspective different than the first perspective or the second perspective.

19. The system of claim 17, wherein the third image is a combination of the left eye image and the right eye image.

20. The system of claim 16, wherein the third subset of subpixels are an interocular subset of the plurality of subpixels that emit light that intersects an interocular region of a viewer.
